(19) United States
(12) Patent Application Publication
(10) Pub. No.: US 2022/0404290 A1
(43) Pub. Date: Dec. 22, 2022

(54) DETECTION DEVICE PREVENTING DAMAGE TO DETECTION MODULE FROM HEAT GENERATED BY LIGHT SOURCE

(71) Applicants: HONGFUJIN PRECISION ELECTRONICS (ZHENGZHOU) CO., LTD., Zhengzhou (CN); Henan Fuchi Technology Co., Ltd., Zhengzhou (CN)

(72) Inventors: CHIA-WEI HSU, New Taipei (TW); HSIN-TA LIN, New Taipei (TW)

(73) Assignees: HONGFUJIN PRECISION ELECTRONICS (ZHENGZHOU) CO., LTD., Zhengzhou (CN); Henan Fuchi Technology Co., Ltd., Zhengzhou (CN); Henan Fuchi Technology Co., Ltd., Zhengzhou (CN)

(21) Appl. No.: 17/829,600

(22) Filed: Jun. 1, 2022

(30) Foreign Application Priority Data
Jun. 22, 2021 (CN) 202110691633.1

(51) Int. Cl. G01N 21/88; G01N 21/15; G01N 21/17; F21V 29/76

(52) U.S. Cl. CPC G01N 21/8806; G01N 21/15; G01N 21/17; F21V 29/763; G01N 2021/177; G01N 2201/061; F21W 2131/40

(57) ABSTRACT

A detection device includes a cover, a detection module, and a light source. The cover includes a top wall and a sidewall connected to the top wall. The top wall and the sidewall cooperatively define a receiving cavity. The sidewall includes a first portion close to the top wall and a second portion away from the top wall. The detection module is disposed on the top wall. The light source is disposed on the second portion. The influence of heat on proper operation of the detection device is prevented.

### FIELD

The subject matter herein generally relates to electronic and optical devices, and more particularly, to a detection device.

### BACKGROUND

Before products are manufactured in mass production, detection devices are used to detect the quality of each product.

In use, the detection device acquires images of a product, and uses various types of image processing algorithms to analyze the images to determine whether the product has unqualified appearance (such as surface defects). To acquire an image of the product, a light source is needed to illuminate the product. However, the light source may generate heat as well as light. The heat may reach the detection module of the detection device, thereby affecting the operation and accuracy of the detection module, even resulting in failure of the detection module.

Therefore, there is room for improvement in the art.

### BRIEF DESCRIPTION OF THE DRAWINGS

Implementations of the present technology will now be described, by way of embodiment, with reference to the attached figures.

FIG. 1 is a diagrammatic view of a detection device according to an embodiment of the present disclosure.

FIG. 2 is a diagrammatic view of a light source of the detection device of FIG. 1.

FIG. 3 is a diagrammatic view of a detection device according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

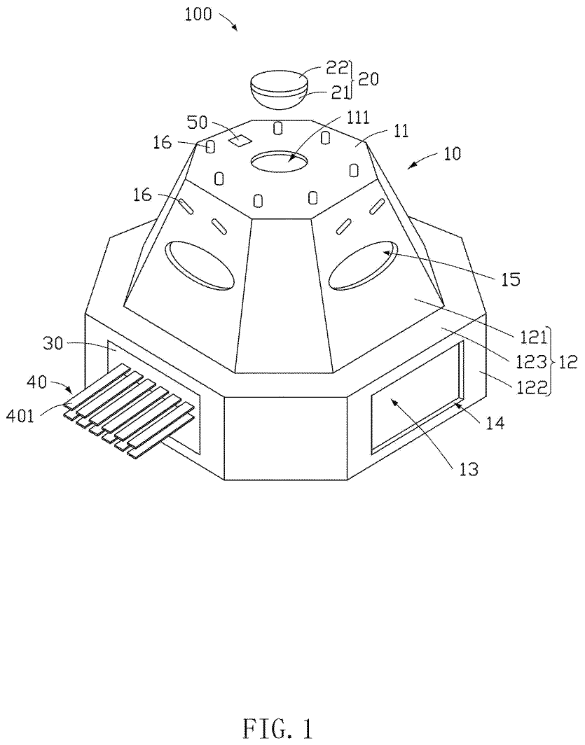

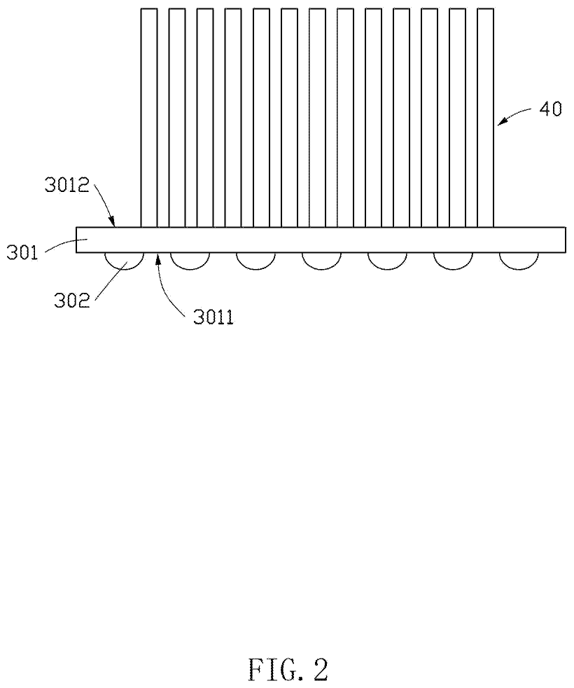

Referring to FIGS. 1 and 2, a detection device 100 is provided according to an embodiment of the present disclosure. The detection device 100 includes a cover 10, a detection module 20, at least one light source 30, and a heat dissipation device 40. The heat dissipation device 40 is disposed on the light source 30. The detection module 20 and the light source 30 are disposed on the cover 10. The cover 10 is used to converge light emitted by the light source 30 towards a product (not shown) placed under the cover 10. As such, the product is illuminated.

Referring to FIG. 1, the cover 10 includes a top wall 11 and a sidewall 12 connected to the top wall 11. The top wall 11 and the sidewall 12 cooperatively define a receiving cavity 13. In use, a product (not shown) is placed under the cover 10, and is disposed on a side of the cover 10 away from the top wall 11. The top wall 11 is recessed towards the receiving cavity 13 to form a mounting groove 111. The mounting groove 111 passes through the top wall 11. The detection module 20 is disposed in the mounting groove 111. In at least one embodiment, a bottom surface of the mounting groove 111 may have a stepped shape.

The sidewall 12 includes a first portion 121 close to the top wall 11 and a second portion 122 away from the top wall 11. The light source 30 is disposed on the second portion 122. The sidewall 12 may also include a connecting portion 123 connecting the first portion 121 to the second portion 122. The first portion 121 is between the top wall 11 and the connecting portion 123. An included angle between the first portion 121 and the connecting portion 123 is in a range of 0 degree to 180 degrees. An included angle between the connecting portion 123 and the second portion 122 is in a range of 0 degree to 180 degrees. As such, the cover 10 achieves a better effect of light converging. In at least one embodiment, the included angle between the first portion 121 and the connecting portion 123 is in a range of 60 degrees to 120 degrees, and the included angle between the connecting portion 123 and the second portion 122 is in a range of 60 degrees to 120 degrees. In at least one embodiment, the included angle between the connecting portion 123 and the second portion 122 is 90 degrees. As such, the cover 10 achieves a better effect of light converging. Furthermore, a distance between the top wall 11 and the second portion 122 is increased. That is, a distance between the detection module 20 and the light source 30 on the cover 10 is increased. Thus, heat transferred to the detection module 20 from the light source 30 is reduced.

In at least one embodiment, the first portion 121 is a frustum of a pyramid, and the second portion 122 is a polygon.

The detection module 20 includes a camera 21 and an electric control component 22 electrically connected to the camera 21. The camera 21 receives the light reflected by the product and forms an image accordingly. The electric control component 22 receives and analyzes the image to determine characteristic information (such as surface defects) of the product. A control module 50 is also disposed outside the cover 10. The control module 50 is electrically connected to the detection module 20 and the light source 30, and used to control the working state of the detection module 20 and the light source 30.

Referring to FIGS. 1 and 2, The second portion 122 of the cover 10 defines at least one through hole 14. Each light source 30 is disposed in a corresponding one of the at least one through hole 14. Each light source 30 includes a substrate 301 disposed in the through hole 14 and at least one light emitting unit 302 disposed on the substrate 301. In at least one embodiment, a number of light emitting units 302 are included, and each light emitting unit 302 may be an LED lamp. The substrate 301 includes a first surface 3011 facing the receiving cavity 13 and a second surface 3012 opposite to the first surface 3011. The light emitting unit 302 is disposed on the first surface 3011. Thus, the light emitted by the light emitting unit 302 can illuminate the product placed under the cover 10. In at least one embodiment, a number of through holes 14 are defined in the second portion 122 of the cover 10. A number of light sources 30 are included in the detection device 100, and each light source 30 is disposed in a corresponding one of the through holes 14. The light sources 30 provide light with sufficient intensity to illuminate the product, and more reflected light from the product is received by the detection module 20.

Referring to FIGS. 1 and 2, the heat dissipation device 40 is mounted on the second surface 3012 of the substrate 301, and used to dissipate heat generated by the light source 30. The heat dissipation device 40 includes a plurality of heat dissipation fins 401. The heat dissipation fins 401 may be made of a metal material such as aluminum or magnesium. The heat dissipation fins 401 may also be made of alloy. In another embodiment, the heat dissipation device 40 may also include a vapor chamber, a heat pipe, or a combination thereof. In other embodiments, the heat dissipation device 40 may also be disposed on the top wall 11 of the cover 10.

In at least one embodiment, a number of heat dissipation holes 15 are defined in the first portion 121. The heat dissipation holes 15 enhance air circulation between the receiving cavity 13 and the ambient environment, thereby dissipate heat generated by the light source 30. Furthermore, the heat dissipation holes 15 block a portion of the heat generated by the light source 30 from being transferred to the detection module 20.

Referring to FIG. 1, in at least one embodiment, the cover 10 may be made of plastic, or metals or alloys with a small heat conductivity. Thus, the heat transferred from the light source 30 to the detection module 20 is reduced. A number of protrusions 16 are disposed on the top wall 11 of the cover 10. The protrusions 16 may be fin-shaped, so as to increase a contact area between the cover 10 and air. Thus, the protrusions 16 further increase the heat dissipate efficiency. In other embodiments, the protrusions 16 may also be arranged on the sidewall 12 of the cover 10.

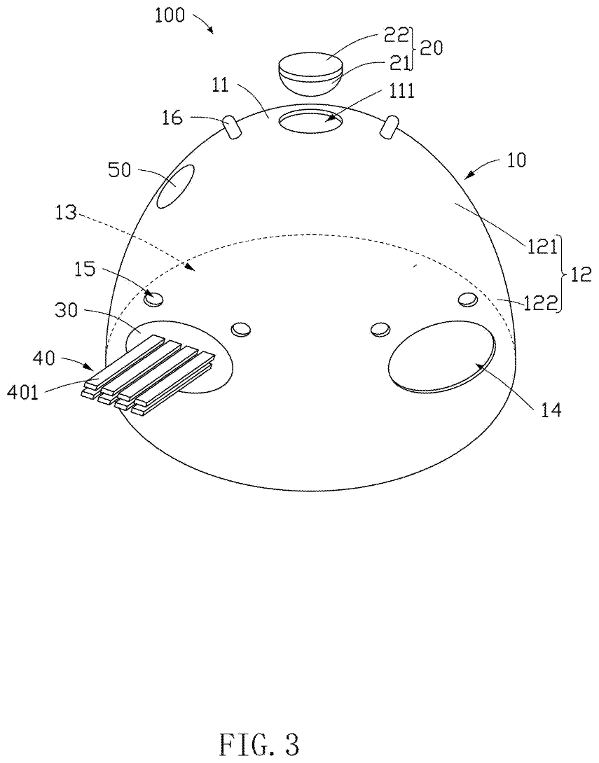

Referring to FIG. 3, in another embodiment, the entire sidewall 12 is arcuate. Specifically, the first portion 121 and the second portion 122 of the sidewall 12 cooperatively form an arcuate surface, which is convex away from the receiving cavity 13. Thus, the space of the receiving cavity 13 is enlarged. In this embodiment, the upper half portion of the sidewall 12 can be regarded as the first portion 121, and the lower half portion of the sidewall 12 can be regarded as the second portion 122.

With the above configuration, the detection module 20 is disposed on the top wall 11 of the cover 10, and the light source 30 is disposed on the second portion 122 of the sidewall 12 away from of the top wall 11. As such, the distance between the light source 30 and the detection module 20 is increased, that is, the path for the delivery of heat from the light source 30 to the detection module 20 is lengthened. Therefore, when heat is accumulated on the light source 30, during the transfer of heat from the light source 30 to the detection module 20, a large portion of the heat is dissipated into air, thereby reducing the heat transferred to the detection module 20. Moreover, the cover 10 increases the contact area between the light source 30 and the air, and thus allowing the heat from the light source 30 to be dissipated into the receiving cavity 13. Thus, the heat dissipation efficiency is improved, thereby reducing risk of heat-derived malfunction of the detection module 20.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A detection device, comprising:
a cover comprising a top wall and a sidewall connected to the top wall, the top wall and the sidewall cooperatively defining a receiving cavity, the sidewall comprising a first portion close to the top wall and a second portion away from the top wall;
a detection module disposed on the top wall; and
at least one light source disposed on the second portion.

2. The detection device according to claim 1, wherein a mounting groove is defined on the top wall, the detection module is disposed in the mounting groove.

3. The detection device according to claim 1, wherein the sidewall further comprises a connecting portion connected between the first portion and the second portion, the first portion is connected between the top wall and the connecting portion.

4. The detection device according to claim 3, wherein an included angle between the first portion and the connecting portion is in a range of 0 degree to 180 degrees, an included angle between the connecting portion and the second portion is in a range of 0 degree to 180 degrees.

5. The detection device according to claim 4, wherein the included angle between the first portion and the connecting portion is in a range of 60 degrees to 120 degrees, the included angle between the connecting portion and the second portion is in a range of 60 degrees to 120 degrees.

6. The detection device according to claim 3, wherein the first portion is a frustum of a pyramid, the second portion is a polygon.

7. The detection device according to claim 1, wherein the sidewall has an arcuate surface and is convex away from the receiving cavity.

8. The detection device according to claim 1, wherein a plurality of protrusions are disposed on at least one of the top wall and the sidewall.

9. The detection device according to claim 1, wherein at least one through hole is defined in the second portion, the at least one through hole communicates with the receiving cavity, the at least one light source is installed in the at least one through hole.

10. The detection device according to claim 9, wherein each of the at least one light source comprises a substrate and a light emitting unit, the substrate of each of the at least one light source is disposed in the corresponding one of the at least one through hole, the substrate comprises a first surface facing the receiving cavity and a second surface opposite to the first surface, the light emitting unit is disposed on the first surface.

11. The detection device according to claim 10, further comprising a heat dissipation device disposed on the second surface.

12. The detection device according to claim 11, wherein the heat dissipation device comprises at least one of a heat dissipation fin, a vapor chamber, and a heat pipe.

13. The detection device according to claim 9, wherein the at least one light source comprises a plurality of light sources, the at least one through hole comprises a plurality of through holes, each of the plurality of light sources is disposed in a corresponding one of the plurality of through holes.

14. The detection device according to claim 1, wherein a heat dissipation hole is defined in the first portion.

15. The detection device according to claim 1, wherein the detection module comprises a camera and an electric control component electrically connected to the camera, the camera is configured to receive light reflected by a product placed in the receiving cavity and form an image, the electric control component is configured to analyze the image to determine characteristic information of the product.

16. The detection device according to claim 1, wherein the cover is made of plastic.
